(19) United States
(12) Patent Application Publication
(10) Pub. No.: US 2017/0300322 A1
(43) Pub. Date: Oct. 19, 2017

(54) ARITHMETIC PROCESSING DEVICE, METHOD, AND SYSTEM

(71) Applicant: FUJITSU LIMITED, Kawasaki-shi (JP)

(72) Inventors: Takahito HIRANO, Kawasaki (JP); Noriko TAKAGI, Kawasaki (JP)

(73) Assignee: FUJITSU LIMITED, Kawasaki-shi (JP)

(21) Appl. No.: 15/478,528

(22) Filed: Apr. 4, 2017

(30) Foreign Application Priority Data
Apr. 15, 2016 (JP) 2016-082247

(51) Int. Cl. G06F 9/30; G06F 9/38; G06F 12/08

(52) U.S. Cl. CPC G06F 9/3001; G06F 12/0875; G06F 9/30072; G06F 12/0897; G06F 9/30043; G06F 9/3836; G06F 2212/452; G06F 2212/60

(57) ABSTRACT

An arithmetic processing device includes: an instruction control circuit; primary cache circuit that includes a primary cache memory and a first buffer; and a secondary cache memory. The primary cache circuit is configured to, when a first instruction for executing processing to register data of a cache line in the secondary cache memory without the occurrence of an access to the main memory, is issued from the instruction control circuit and when data corresponding to a first address designated as an access target in the first instruction is not stored in the primary cache memory, store the first address in the first buffer and issue the first instruction to the secondary cache memory.

### CROSS-REFERENCE TO RELATED APPLICATION

This application is based upon and claims the benefit of priority of the prior Japanese Patent Application No. 2016-082247, filed on Apr. 15, 2016, the entire contents of which are incorporated herein by reference.

### FIELD

The embodiment discussed herein relates to an arithmetic processing device, a method, and a system.

### BACKGROUND

A store-in method (write-back method) is known as a method for controlling a cache memory in a processor used as an arithmetic processing device. The store-in method is explained with reference to FIG. 6. FIG. 6 is a diagram for explaining a control based on the store-in method. When executing a store instruction in a processor 611 that uses the store-in method, an instruction control unit 612 issues a store instruction STRI, and data STRD corresponding to the store instruction STRI is output from an execution unit 613. The data STRD is then written into a primary cache memory 615 inside a storage unit 614 and into a secondary cache memory 617 inside an external coupling unit 616, and the data STRD is not written into a main storage device 618.

As a result, when other data is held in a location in which the data is being held in the aforementioned secondary cache memory 617 in the store-in method, data that has already been registered in a cache line is written into the main storage device 618 for saving. At this time, the processor 611 writes the data registered in the cache line into the main storage device 618 and invalidates the cache line, and newly registers the other data in the invalidated cache line. As a result, the data written into the cache line is reflected in the main storage device 618. Moreover, by using the store-in method, store instruction processing is completed without waiting for the writing into the main storage device 618.

FIG. 7 is a flow chart for depicting a processing flow of store instructions in a processor that uses the store-in method. In step S701, the storage unit 614, which executes a store instruction from the instruction control unit 612, determines whether data corresponding to a store target address is stored in the primary cache memory 615 (whether there is a cache hit). If the storage unit 614 determines that the data is stored in the primary cache memory 615 (there is a cache hit) (S701: Yes), in step S702, the storage unit 614 executes store processing and registers the store target data to the address corresponding to the cache hit.

However, if the storage unit 614 determines that the data is not stored in the primary cache memory 615 (there is a cache miss) (S701: No), in step S703, the external coupling unit 616 determines whether the data corresponding to the store target address is being held in the secondary cache memory 617 (whether there is a cache hit). If the external coupling unit 616 determines that the data is being held in the secondary cache memory 617 (there is a cache hit) (S703: Yes), in step S704, the external coupling unit 616 registers the data of the secondary cache memory 617 to the primary cache memory 615. The processor 611 then returns to step S701 and executes the processing thereafter.

If the external coupling unit 616 determines that no data is being held in the secondary cache memory 617 (there is a cache miss) (S703: No), in step S705, the external coupling unit 616 loads (reads) the data stored in the store target address from the main storage device 618. Next, in step S706, the external coupling unit 616 registers the data loaded from the main storage device 618 to each of the store target addresses in the primary cache memory 615 and the secondary cache memory 617. The processor 611 then returns to step S701 and executes the processing thereafter.

When memory initialization is carried out for initializing the main storage device or when memory copy processing is carried out for copying the data stored in a certain address to another address in the main storage device in the store-in method, processing for writing the data continuously in the main storage device is initiated. As a result, when the memory initialization and the memory copy processing are carried out, multiple operations (operations corresponding to S705 and S706 in FIG. 7) are initiated for loading the data stored in the store target address from the main storage device and registering the data in a cache memory in the processor, and the processing time increases by a large amount.

Because the data stored in the store target address in the main storage device is all replaced due to the store data during the memory initialization or memory copy processing, any data that does not have errors may be used. Accordingly, a processor that uses a cache line fill instruction (referred to below as XFILL instruction) for executing processing to register the data of the cache line in the secondary cache memory without generating an access to the main storage device, has been proposed as pre-processing of specific instructions such as memory initialization or memory copy in a processor that uses the store-in method.

FIG. 8 illustrates a processing flow of a cache line fill instruction (XFILL instruction) in a processor that uses the store-in method. In step S801, the storage unit 614, which executes an XFILL instruction from the instruction control unit 612, determines whether data corresponding to an XFILL target address is stored in the primary cache memory 615 (whether there is a cache hit).

If the storage unit 614 determines that data is stored in the primary cache memory 615 (there is a cache hit) (S801: Yes), the routine advances to step S806 after sending an XFILL instruction completion notification to the instruction control unit 612, and the processor 611 executes the store processing on the XFILL target address corresponding to a subsequent instruction. A subsequent instruction, for example, is an instruction for carrying out memory initialization or processing such as memory copy.

If the storage unit 614 determines that the data is not stored in the primary cache memory 615 (there is a cache miss) (S801: No), in step S802, the storage unit 614 issues an XFILL request to the external coupling unit 616 as depicted in FIG. 9. FIG. 9 is a flow chart for explaining processing when issuing the XFILL request to the external coupling unit 616 from the storage unit 614.

First, in step S901, processing is executed by a store buffer control unit in the storage unit 614. When the data corresponding to the XFILL target address registered in the store buffer is stored in the primary cache memory 615 (there is a primary cache hit), the store buffer control unit releases the store buffer to which the XFILL target address is registered and does not secure a write buffer (processing finished). If the data corresponding to the XFILL target address registered in the store buffer is not stored in the primary cache memory 615 (there is a primary cache miss), the store buffer control unit moves the XFILL target address after committing from the store buffer to the write buffer and releases the store buffer.

Next, in step S902, processing is executed by a write buffer control unit in the storage unit 614. The write buffer control unit moves the XFILL target address from the write buffer to an address register. The write buffer control unit then issues an XFILL request to the external coupling unit 616 and releases the write buffer to which the XFILL target address is registered. In step S903, the storage unit 614 then issues the XFILL request to the external coupling unit 616.

Returning to FIG. 8, in step S803, the external coupling unit 616 that receives the XFILL request from the storage unit 614 determines whether the data corresponding to the XFILL target address is being held in the secondary cache memory 617 (whether there is a cache hit). If the external coupling unit 616 determines that the data is being held in the secondary cache memory 617 (there is a cache hit) (S803: Yes), in step S805, the external coupling unit 616 sends an XFILL instruction completion notification to the instruction control unit 612 and the storage unit 614. Next, in step S806, the processor 611 executes the store processing pertaining to the XFILL target address corresponding to the subsequent instruction.

If the external coupling unit 616 determines that the data is not being held in the secondary cache memory 617 (there is a cache miss) (S803: No), in step S804, the external coupling unit 616 writes zero data in the XFILL target address in the secondary cache memory 617 and enables a registration tag of the cache line to which the zero data is registered. Next, the processing of the aforementioned steps S805 and S806 is executed. By using the XFILL instruction in this way, the processing time corresponding to the memory initialization and memory copy processing can be shortened.

Japanese Laid-open Patent Publication No. 2011-138213 is known as an example of the related art.

### SUMMARY

According to an aspect of the invention, an arithmetic processing device includes: an instruction control circuit configured to issue an instruction; a secondary cache memory configured to store a portion data of data stored in a main memory; and a primary cache circuit that includes a primary cache memory and a first buffer, the primary cache memory storing a portion data of the portion data stored in the secondary cache memory, and the first buffer storing an address for obtaining data from the secondary cache memory in a case where a cache miss is occurred in the primary cache memory. When a first instruction for executing processing to register data of a cache line in the secondary cache memory without the occurrence of an access to the main memory, is issued from the instruction control circuit and when data corresponding to a first address designated as an access target in the first instruction is not stored in the primary cache memory, the primary cache circuit is configured to: store the first address in the first buffer, and issue the first instruction to the secondary cache memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of an arithmetic processing device according to the present embodiment;

FIG. 2 is a flow chart for explaining processing when issuing an XFILL request to an external coupling unit according to the present embodiment;

FIG. 3 is a view for explaining XFILL instruction processing operations according to the present embodiment;

FIG. 4 is a time chart depicting an example of XFILL instruction processing according to the present embodiment;

FIG. 5 illustrates a configuration example of a subsequent instruction inhibiting circuit according to the present embodiment;

FIG. 6 is a diagram for explaining control based on the store-in method;

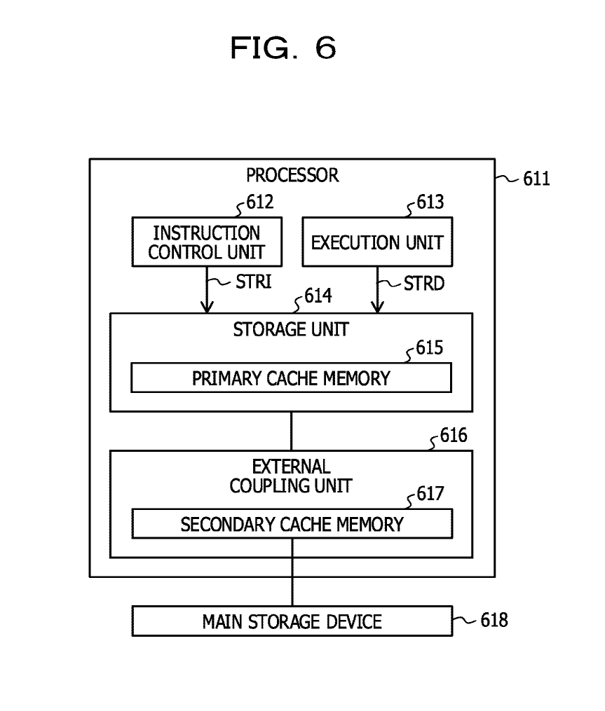

FIG. 7 is a flow chart for depicting a processing flow of store instructions in a processor that uses the store-in method;

FIG. 8 is a flow chart for depicting a processing flow of an XFILL instruction in a processor that uses the store-in method; and

FIG. 9 is a flow chart for explaining processing when issuing an XFILL request to an external coupling unit.

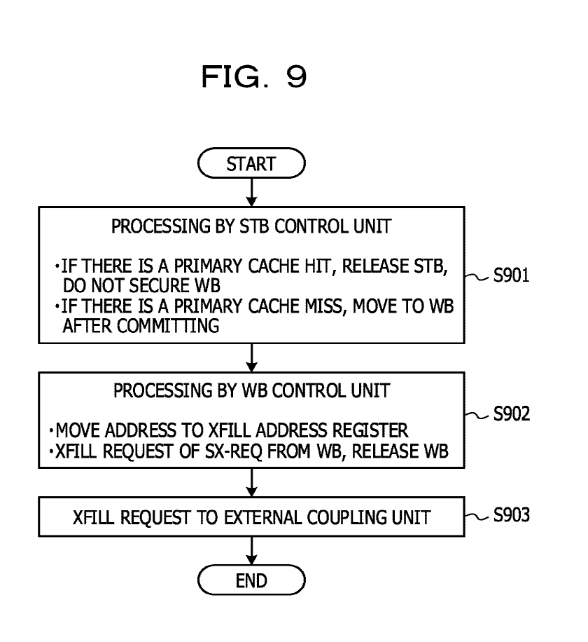

### DESCRIPTION OF EMBODIMENT

When carrying out processing which includes XFILL instructions, the order of memory accesses is preferably guaranteed without the use of membar (memory barrier) instructions in order to increase processing speeds. A membar instruction is an instruction for carrying out the serialization of the memory accesses. When a membar instruction is executed after a certain store instruction has been executed, the execution of the instruction to be executed thereafter is guaranteed after the execution of the store instruction is completed. However, the processing speed of the processor may be reduced.

The order of memory accesses during processing that includes XFILL instructions is guaranteed without the use of membar instructions by detecting the following conditions.

(1) The XFILL instruction is executed after the load processing or store processing of a prior instruction is completed in order to guarantee the completion of the load processing or store processing of the prior instruction which accesses the same storage region as the XFILL instruction. This condition is the same for store instruction processing and thus can be realized by processing as a store instruction.

(2) An address register is prepared which indicates an address region during the execution of processing for registering the data in the cache line, and the completion of the load processing or store processing of a subsequent instruction which accesses the same storage region is delayed in order to inhibit the load processing or store processing of the subsequent instruction which accesses the same storage region as the XFILL instruction.

Therefore, by preparing an address register for holding the XFILL target address in response to the number of XFILL instructions to be executed in the same time period, a plurality of XFILL instructions can be carried out in the same time period. Moreover, higher processing speeds can be realized by providing a dedicated address register for holding the XFILL target addresses in order to process the XFILL instructions and subsequent store instructions which differ from the series of store instructions. However, when multiple dedicated address registers for holding XFILL target addresses are provided in accordance with the number of XFILL instructions to be executed in the same time period, the quantity of circuitry may increase. An object according to one aspect is to execute a plurality of XFILL instructions without causing an increase in the quantity of circuitry.

The present embodiment will be explained below with reference to the drawings.

When executing a cache line fill instruction (XFILL instruction), a dedicated address register is provided and the XFILL target address is held in the address register according to the prior art. In the embodiment explained below, the XFILL target address is held in an address holding buffer (MIAAR) for refill in a move-in buffer (MIB) provided in a storage unit (primary cache unit) without providing a dedicated address register for holding the XFILL target address.

The address holding buffer (MIAAR) for refill is a buffer for keeping addresses requested for obtaining data from a secondary cache memory when there is a cache miss in a primary cache memory. The address holding buffer (MIAAR) for refill has a plurality of entries and is able to hold a plurality of addresses. According to the present embodiment, a plurality of XFILL instructions can be executed without an increase in the quantity of the circuitry by sharing a previously existing address holding buffer (MIAAR) for refill and using the same for holding the XFILL target addresses.

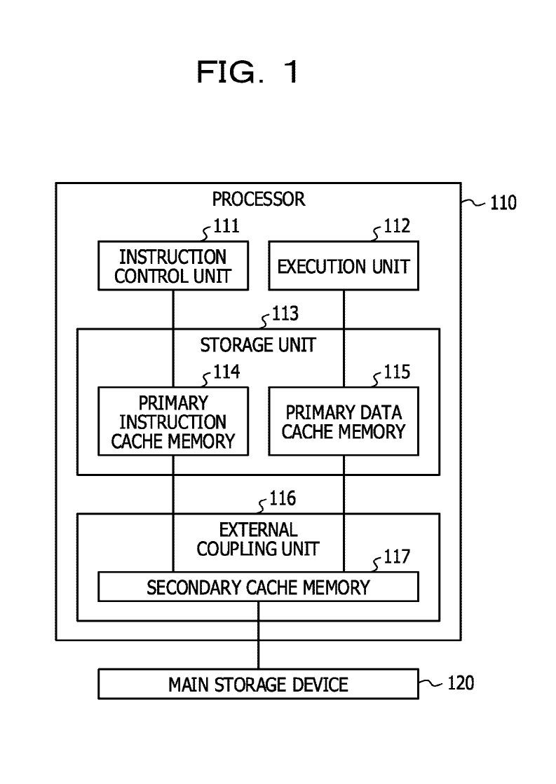

FIG. 1 is a block diagram illustrating a configuration example of a processor as an arithmetic processing device according to the present embodiment. A processor 110 according to the present embodiment has an instruction control unit (IU) 111, an execution unit (EU) 112, a storage unit (SU) 113 as a primary cache unit, and an external coupling unit (SX: secondary cache and external access unit) 116.

The processor 110 according to the present embodiment uses a store-in (write-back) method as a method for controlling a cache memory. The processor 110 has an instruction pipeline and is coupled to a main storage device (main memory) 120. The main storage device 120 is a memory capable of storing large amounts of data in comparison to a cache memory. The main storage device 120 stores instructions and data. The main storage device 120 is, for example, a random access memory (RAM).

The instruction control unit 111 issues a series of instructions previously defined by a compiler (program) in the order of the instructions. The instruction control unit 111 issues store instructions for storing data and load instructions for loading data, for example, to the storage unit 113. Further, the instruction control unit 111 issues an XFILL instruction, for example, to the storage unit 113. An XFILL instruction is an instruction for executing pre-processing before executing a store instruction when initializing a predetermined storage region of the main storage device 120 (memory initialization) or a store instruction when copying data stored in a predetermined storage region to another storage region in the main storage device (memory copy). The instruction control unit 111 outputs the XFILL instruction to the store target address as pre-processing of a store instruction output when outputting the store instruction corresponding to the memory initialization or memory copy.

XFILL instruction processing is executed to determine if the data is stored in the storage region to be initialized or the storage region of the copy destination in the main storage device 120 is being held in the secondary cache memory 117 controlled by the store-in method. Next, if it is determined that the data is not being held in the secondary cache memory 117, XFILL instruction processing is executed to register the predetermined data in a cache line of the secondary cache memory 117 corresponding to the storage region to be initialized or the storage region of the copy destination in the main storage device 120, and to validate a registration tag of the cache line.

The execution unit 112 carries out various types of computing such as arithmetic computing, logical computing, or address calculation, and stores the computing results in a primary data cache memory 115 of the storage unit 113. The storage unit 113 stores instructions output by the instruction control unit 111 and the computing results computed by the execution unit 112. The storage unit 113 has a primary instruction cache memory 114 and the primary data cache memory 115. Moreover, the storage unit 113 outputs the XFILL instruction received from the instruction control unit 111, for example, to the external coupling unit 116 to request the execution and the like of the instruction, and inhibits the execution of a subsequent instruction which accesses the same storage region as the XFILL instruction being executed.

The primary instruction cache memory 114 is a cache memory which allows faster accessing than the secondary cache memory 117. The primary instruction cache memory 114 stores a portion of the instructions stored in the main storage device 120. The primary data cache memory 115 is a cache memory which allows faster accessing than the secondary cache memory 117. The primary data cache memory 115 stores a portion of the data stored in the main storage device 120. The external coupling unit 116 has the secondary cache memory 117 and implements various types of controls with the storage unit 113 or the main storage device 120. The secondary cache memory 117 holds a portion of the instructions or data stored in the main storage device 120 as instructions or data to be referenced by the processor 110.

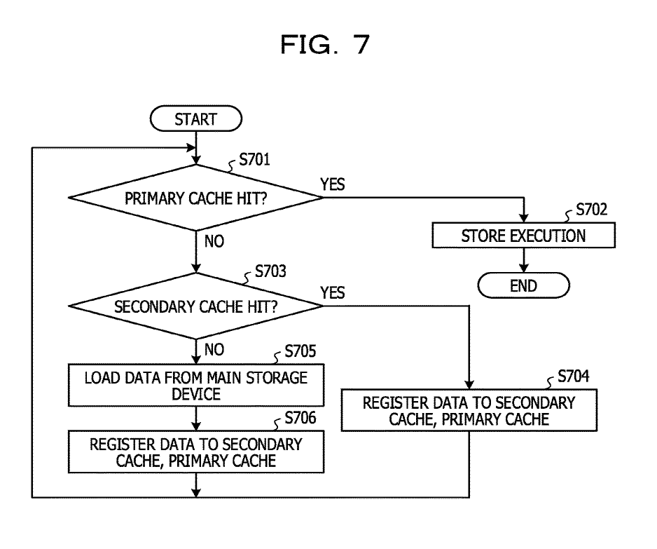

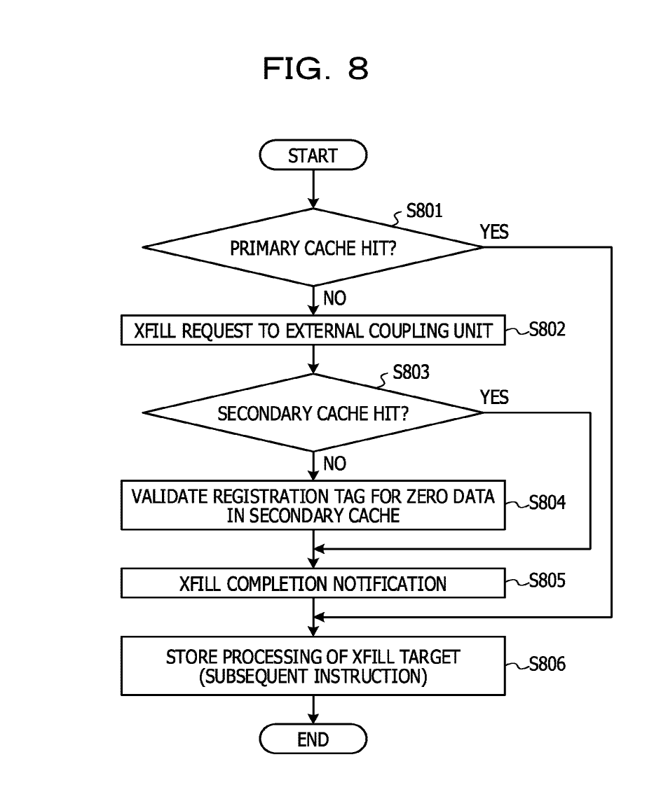

Next, the processing by the processor according to the present embodiment will be discussed. The basic operations of the store instruction processing and the XFILL instruction processing by the processor according to the present embodiment are similar to the processing depicted in FIG. 7 or FIG. 8 and the explanation thereof will be omitted. The processing when issuing an XFILL request from the storage unit to the external coupling unit within the XFILL instruction processing is different from the processing depicted in the aforementioned drawings in the processor according to the present embodiment.

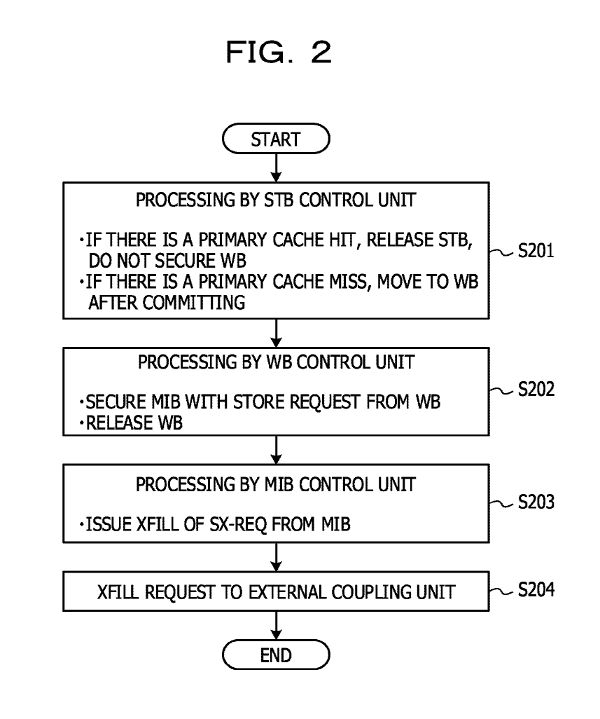

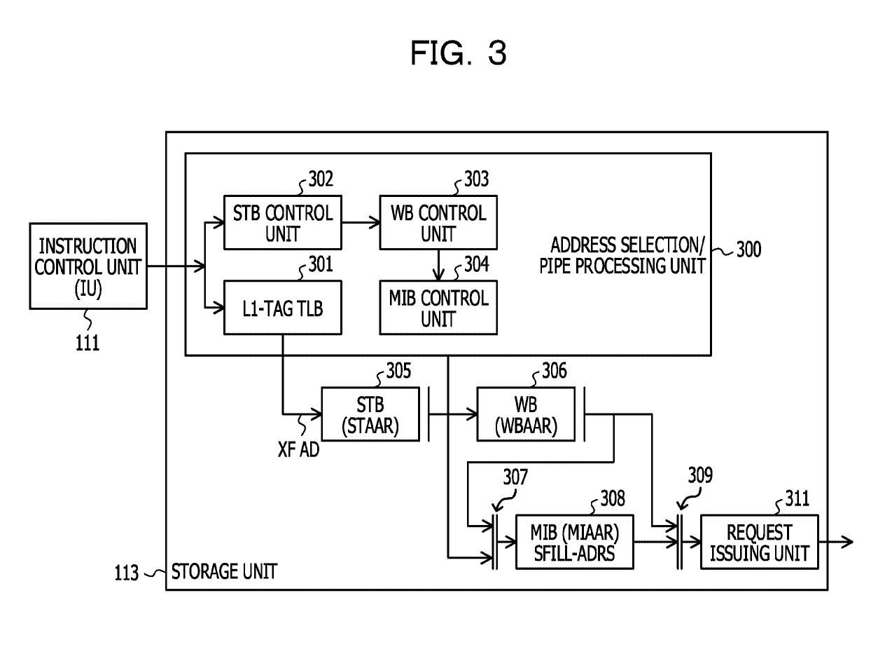

Processing when issuing the XFILL request from the storage unit 113 to the external coupling unit 116 in the processor according to the present embodiment is explained with reference to FIG. 2 and FIG. 3. FIG. 2 is a flow chart for explaining processing when issuing the XFILL request from the storage unit 113 to the external coupling unit 116 according to the present embodiment. FIG. 3 is a view for explaining the processing operations of the XFILL instruction according to the present embodiment, and depicts a flow of addresses.

As illustrated in FIG. 3, the storage unit 113 has an address selection/pipe processing unit 300, a store buffer (STB) 305, a write buffer (WB) 306, a move-in buffer (MIB) 308, selectors 307 and 309, and a request issuing unit 310. The address selection/pipe processing unit 300 has a tag/TLB unit 301, a store buffer control unit 302, a write buffer control unit 303, and a move-in buffer control unit 304.

The address selection/pipe processing unit 300 introduces an address that is the target of an instruction output by the instruction control unit 111 into an instruction pipeline. The tag/TLB unit 301 compares the address that is the target of the instruction output by the instruction control unit 111 with tag addresses of the data stored in the primary data cache memory 115, or refers to a translation lookaside buffer (TLB) and carries out address conversion (conversion from a virtual address to a physical address).

The store buffer control unit 302 carries out controls pertaining to the store buffer 305. The store buffer 305 has a plurality of entries. The store buffer 305 is a buffer for processing store instructions from the instruction control unit 111 or instructions pertaining to store processing such as XFILL instructions and the like. The write buffer control unit 303 carries out controls pertaining to the write buffer 306. The write buffer 306 has a plurality of entries. The write buffer 306 is a buffer for carrying out data request processing for storing store instructions and the like that have been committed and registering store data in the primary data cache memory 115, or for requesting data to be stored in the secondary cache memory 117. The move-in buffer control unit 304 carries out controls pertaining to the move-in buffer 308. The move-in buffer 308 has a plurality of entries. The move-in buffer 308 is a buffer for carrying out data request processing to the secondary cache memory 117 when there is a cache miss in the primary data cache memory 115.

The selector 307 selectively outputs, to the move-in buffer 308, an address output by the address selection/pipe processing unit 300 (address pertaining to refill processing) and an XFILL target address output by the write buffer 306. The selector 309 selectively outputs, to the request issuing unit 310, a store target address output by the write buffer 306 and an address output by the move-in buffer 308 (address pertaining to the refill processing or an XFILL target address). The request issuing unit 310 issues the request having the address output by the selector 309 as the target, to the external coupling unit 116.

As illustrated in FIG. 2, when the XFILL instruction is issued from the instruction control unit 111 to the storage unit 112, the processing by the store buffer control unit 302 in the storage unit 113 is executed in step S201. When the data corresponding to the XFILL target address registered to an address holding unit (STAAR) in the store buffer 305 is stored in the primary data cache memory 115 (there is a primary cache hit), the store buffer control unit 302 releases the entries of the store buffer 305 to which the XFILL target address is registered and does not secure an entry of the write buffer 306 (processing finished).

Moreover, when the data corresponding to the XFILL target address registered to the address holding unit (STAAR) in the store buffer 305 is not stored in the primary data cache memory 115 (there is a primary cache miss), the store buffer control unit 302 moves the XFILL target address after committing from the store buffer 305 to the write buffer 306 and registers the XFILL target address to an address holding unit (WBAAR) in the write buffer 306. The store buffer control unit 302 then releases the entry of the store buffer 305 to which the XFILL target address is registered.

Next, in step S202, processing is executed by the write buffer control unit 303 in the storage unit 113. The write buffer control unit 303 issues a store request to the move-in buffer 308, secures an entry in the move-in buffer 308, and registers the XFILL target address in the address holding buffer (MIAAR) for refill in the move-in buffer 308. The write buffer control unit 303 then releases the entry of the write buffer 306 to which the XFILL target address is registered.

Next, in step S203, processing is executed by the move-in buffer control unit 304 in the storage unit 113. The move-in buffer control unit 304 requests the request issuing unit 310 to issue an XFILL request pertaining to the XFILL target address registered to the address holding buffer (MIAAR) of the move-in buffer 308. Next in step S204, the request issuing unit 310 in the storage unit 113 issues the XFILL request to the external coupling unit 116. Thereafter, the storage unit 113 receives the completion notification of the XFILL instruction from the external coupling unit 116 and releases the entry in the move-in buffer 308 to which the XFILL target address is registered.

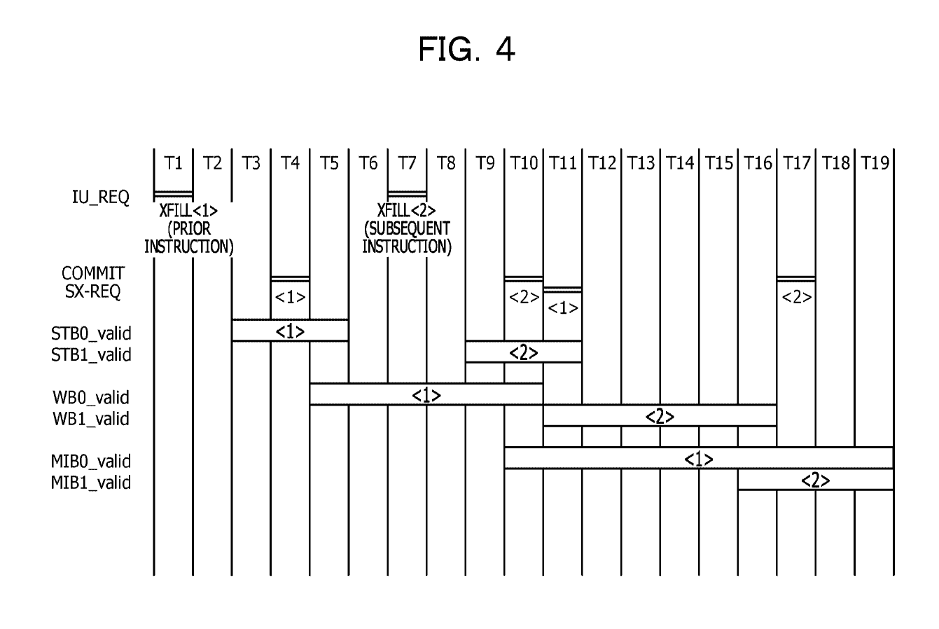

FIG. 4 is a time chart depicting an example of XFILL instruction processing according to the present embodiment. When the XFILL instruction <1> (prior instruction) is issued from the instruction control unit 111 to the storage unit 113 at the time T1, the XFILL target address corresponding to the XFILL instruction <1> is stored in an entry STB0 of the store buffer 305 in the storage unit 113 at the time T3. When the XFILL instruction <1> is committed at the time T4, the XFILL target address corresponding to the XFILL instruction <1> is moved from the entry STB0 of the store buffer 305 to an entry WBO of the write buffer 306 from the subsequent time T5.

Further, when an XFILL instruction <2> (subsequent instruction) is issued from the instruction control unit 111 to the storage unit 113 at the time T7, the XFILL target address corresponding to the XFILL instruction <2> is stored in an entry STB1 of the store buffer 305 in the storage unit 113 at the time T9. When the XFILL instruction <2> is committed at the time T10, the XFILL target address corresponding to the XFILL instruction <2> is moved from the entry STB1 of the store buffer 305 to an entry WB1 of the write buffer 306 from the subsequent time T11.

When the XFILL target address corresponding to the XFILL instruction <1> is moved from the entry WBO of the write buffer 306 to an entry MIBO of the move-in buffer 308 at the time T10, the XFILL request pertaining to the XFILL target address corresponding to the XFILL instruction <1> stored in the MIBO of the move-in buffer 308, is issued from the storage unit 113 to the external coupling unit 116 at the subsequent time T11.

Further, when the XFILL target address corresponding to the XFILL instruction <2> is moved from the entry WB1 of the write buffer 306 to an entry MIB1 of the move-in buffer 308 at the time T16, the XFILL request pertaining to the XFILL target address corresponding to the XFILL instruction <2> stored in the MIB1 of the move-in buffer 308, is issued from the storage unit 113 to the external coupling unit 116 at the subsequent time T17.

In the XFILL instruction processing in the present embodiment, when the data corresponding to the XFILL target address is not stored in the primary data cache memory 115 (there is a primary cache miss), an entry of the move-in buffer 308 is secured and the XFILL target address is registered to the address holding buffer (MIAAR) for refill in the move-in buffer 308. Then, the XFILL request is issued from the move-in buffer 308 to the external coupling unit 116. The address holding buffer (MIAAR) for refill in the move-in buffer 308 is an existing buffer for keeping addresses requested for obtaining data from a secondary cache memory and is able to hold a plurality of addresses when there is a cache miss in a primary cache memory.

Therefore according to the present embodiment, the same number of XFILL instructions as the maximum number of entries in the move-in buffer 308 can be executed at the same time without providing an address register dedicated to XFILL instructions. Consequently, a plurality of XFILL instructions can be executed without causing an increase in the quantity of circuitry according to the present embodiment. For example, if the number of entries in the move-in buffer 308 is 10, a maximum number of 10 XFILL instructions can be executed concurrently.

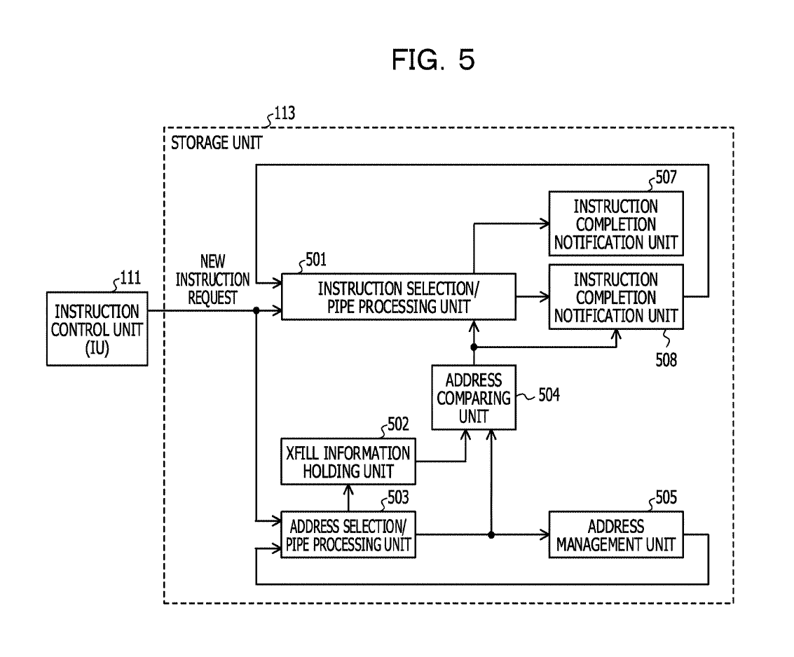

FIG. 5 illustrates a configuration example of a subsequent instruction inhibiting circuit according to the present embodiment. The subsequent instruction inhibiting circuit depicted in FIG. 5 inhibits the execution of a subsequent instruction so that the load processing/store processing based on the subsequent instruction for accessing the same storage region as that of the XFILL instruction is not carried out when executing the XFILL instruction. As illustrated in FIG. 5, the inhibiting circuit is provided in the storage unit 113 and has an instruction selection/pipe processing unit 501, an XFILL information holding unit 502, an address selection/pipe processing unit 503, an address comparing unit 504, an address management unit 505, an instruction completion notification unit 507, and an instruction reintroduction management unit 508.

The instruction selection/pipe processing unit 501 introduces a new instruction request output by the instruction control unit 111 into the instruction pipeline and executes the instruction. When a comparison result from the address comparing unit 504 matches when introducing the instruction into the instruction pipeline, the instruction selection/pipe processing unit 501 inhibits the execution of the instruction and outputs the instruction to the instruction reintroduction management unit 508. If the comparison result does not match, the instruction selection/pipe processing unit 501 introduces the instruction into the instruction pipeline and executes the instruction.

The XFILL information holding unit 502 holds the XFILL target address and a valid hit which indicates whether the XFILL target address is valid or not (whether the XFILL instruction is being executed or not). The XFILL information holding unit 502 corresponds to the move-in buffer 308 to which the XFILL target address is registered.

The address selection/pipe processing unit 503 receives the address that is the target of the instruction output by the instruction control unit 111 and outputs the address to the address comparing unit 504 and the address management unit 505. Further, when an introduction instruction is received from the address management unit 505, the address selection/pipe processing unit 503 introduces the address that is the target of the instruction into the instruction pipeline. When an inhibition instruction is received from the address management unit 505, the address selection/pipe processing unit 503 inhibits the introduction of the address that is the target of the instruction into the instruction pipeline.

The address comparing unit 504 compares the XFILL target address for which the valid hit held in the XFILL information holding unit 502 indicates validity, and the address to be introduced into the instruction pipeline by the address selection/pipe processing unit 503. When an XFILL target address for which the valid hit indicates validity that matches the address to be introduced into the instruction pipeline is present, the address comparing unit 504 notifies the instruction selection/pipe processing unit 501 and the address management unit 505 that the comparison result indicates a match.

The address management unit 505 manages the addresses output by the address selection/pipe processing unit 503. When the comparison result by the address comparing unit 504 indicates a match, the address management unit 505 outputs the address inhibition instruction to the address selection/pipe processing unit 503, and when there is no match, the address management unit 505 outputs the address introduction instruction to the address selection/pipe processing unit 503.

The instruction completion notifying unit 507 monitors whether the execution of the instruction introduced into the instruction pipeline by the instruction selection/pipe processing unit 501 or the instruction reintroduction management unit 508 is completed. When the execution of the instruction is completed, the instruction completion notifying unit 507 outputs the instruction completion notification to the instruction selection/pipe processing unit 501 or the XFILL information holding unit 502 and the like. When the comparison result from the address comparing unit 504 is not a match with respect to the instruction inhibited due to the comparison result of the address comparing unit 504, the instruction reintroduction management unit 508 introduces the inhibited instruction into the instruction pipeline.

When there is a match between the XFILL target address corresponding to an XFILL instruction being executed and a subsequent instruction (load instruction, store instruction, and the like) matching the address, the processing is aborted in the move-in buffer and the execution of the subsequent instruction is inhibited due to the above configuration. Therefore, the order of memory accesses during processing that includes XFILL instructions is guaranteed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An arithmetic processing device comprising:
an instruction control circuit configured to issue an instruction;
a secondary cache memory configured to store a portion data of data stored in a main memory; and
a primary cache circuit that includes a primary cache memory and a first buffer, the primary cache memory storing a portion data of the portion data stored in the secondary cache memory, and the first buffer storing an address for obtaining data from the secondary cache memory in a case where a cache miss is occurred in the primary cache memory,
wherein
when a first instruction for executing processing to register data of a cache line in the secondary cache memory without the occurrence of an access to the main memory, is issued from the instruction control circuit and when data corresponding to a first address designated as an access target in the first instruction is not stored in the primary cache memory,
the primary cache circuit is configured to:
store the first address in the first buffer, and
issue the first instruction to the secondary cache memory.

2. The arithmetic processing device according to claim 1, wherein
the primary cache circuit includes an instruction inhibition circuit that, when the first instruction is issued to the secondary cache memory, inhibits an execution of a subsequent instruction for which a region that is the same as the region of the first address is designated as the access target among one or more subsequent instructions issued after the first instruction, until the processing of the issued first instruction is completed.

3. The arithmetic processing device according to claim 2, wherein the instruction inhibition circuit includes:
a comparing circuit configured to compare the address designated as the access target in a target subsequent instruction among the one or more subsequent instructions, with an address stored in the first buffer, and
a management circuit that, when an address that matches the address designated as the access target in the target subsequent instruction as a result of a comparison by the comparison circuit, is being stored in the first buffer, inhibits the execution of the target subsequent instruction, and when the address that matches the address designated as the access target in the target subsequent instruction is not deleted from the first buffer, instructs the execution of the target subsequent instruction.

4. The arithmetic processing device according to claim 1, wherein
the primary cache circuit includes a store buffer and a write buffer used for a store instruction for writing data, and
when data corresponding to the first address designated as the access target in the first instruction issued by the instruction control circuit, is not stored in the primary cache memory, the first address is stored in the write buffer via the store buffer and the first address stored in the writhe buffer is stored in the first buffer according to a write request from the write buffer.

5. A method executed in an arithmetic processing device including an instruction control circuit configured to issue an instruction, a secondary cache memory configured to store a portion data of data stored in a main memory, and a primary cache circuit that includes a primary cache memory and a first buffer, the primary cache memory storing a portion data of the portion data stored in the secondary cache memory, and the first buffer storing an address for obtaining data from the secondary cache memory in a case where a cache miss is occurred in the primary cache memory, the method comprising:
issuing, by the instruction control circuit, a first instruction for executing processing to register data of a cache line in the secondary cache memory without the occurrence of an access to the main memory;
storing a first address in the first buffer when data corresponding to the first address designated as an access target in the first instruction is not stored in the primary cache memory;
issuing the first instruction with regard to the first address stored in the first buffer to the secondary cache memory.

6. The method according to claim 5, further comprising:
when the first instruction is issued to the secondary cache memory, inhibiting an execution of a subsequent instruction for which a region that is the same as the region of the first address is designated as the access target among one or more subsequent instructions issued after the first instruction, until the processing of the issued first instruction is completed.

7. The method according to claim 6, further comprising:
comparing the address designated as the access target in a target subsequent instruction among the one or more subsequent instructions, with an address stored in the first buffer; and
when an address that matches the address designated as the access target in the target subsequent instruction as a result of a comparison by the comparison circuit, is being stored in the first buffer, inhibiting the execution of the target subsequent instruction, and when the address that matches the address designated as the access target in the target subsequent instruction is not deleted from the first buffer, instructs the execution of the target subsequent instruction.

8. The method according to claim 5, wherein
the primary cache circuit includes a store buffer and a write buffer used for a store instruction for writing data, and
when data corresponding to the first address designated as the access target in the first instruction issued by the instruction control circuit, is not stored in the primary cache memory, the first address is stored in the write buffer via the store buffer and the first address stored in the writhe buffer is stored in the first buffer according to a write request from the write buffer.

9. A system comprising:
a main memory; and
an arithmetic processing device including:
an instruction control circuit configured to issue an instruction,
a secondary cache memory configured to store a portion data of data stored in the main memory, and
a primary cache circuit that includes a primary cache memory and a first buffer, the primary cache memory storing a portion data of the portion data stored in the secondary cache memory, and the first buffer storing an address for obtaining data from the secondary cache memory in a case where a cache miss is occurred in the primary cache memory,
wherein
when a first instruction for executing processing to register data of a cache line in the secondary cache memory without the occurrence of an access to the main memory, is issued from the instruction control circuit and when data corresponding to a first address designated as an access target in the first instruction is not stored in the primary cache memory,
the primary cache circuit is configured to:
store the first address in the first buffer, and
issue the first instruction to the secondary cache memory.

10. The system according to claim 9, wherein
the primary cache circuit includes an instruction inhibition circuit that, when the first instruction is issued to the secondary cache memory, inhibits an execution of a subsequent instruction for which a region that is the same as the region of the first address is designated as the access target among one or more subsequent instructions issued after the first instruction, until the processing of the issued first instruction is completed.

11. The system according to claim 10, wherein the instruction inhibition circuit includes:
a comparing circuit configured to compare the address designated as the access target in a target subsequent instruction among the one or more subsequent instructions, with an address stored in the first buffer, and
a management circuit that, when an address that matches the address designated as the access target in the target subsequent instruction as a result of a comparison by the comparison circuit, is being stored in the first buffer, inhibits the execution of the target subsequent instruction, and when the address that matches the address designated as the access target in the target subsequent instruction is not deleted from the first buffer, instructs the execution of the target subsequent instruction.

12. The system according to claim 9, wherein
the primary cache circuit includes a store buffer and a write buffer used for a store instruction for writing data, and
when data corresponding to the first address designated as the access target in the first instruction issued by the instruction control circuit, is not stored in the primary cache memory, the first address is stored in the write buffer via the store buffer and the first address stored in the writhe buffer is stored in the first buffer according to a write request from the write buffer.
